(19) United States
(12) Patent Application Publication
(10) Pub. No.: US 2010/0171020 A1
(43) Pub. Date: Jul. 8, 2010

(54) CADDY FOR CAR DASHBOARD

(75) Inventors: Serafino Canino, Torrington, CT (US); Scott Gelormino, Burlington, CT (US)

Correspondence Address: THOMPSON HINE L.L.P.;Intellectual Property Group, P.O. BOX 8801, DAYTON, OH, 45401-8801, US

(73) Assignee: ICC INNOVATIVE CONCEPTS CORPORATION, CANTON, CT (US)

(21) Appl. No.: 12/349,379

(22) Filed: Jan. 6, 2009

(51) Int. Cl. B60R 11/00

(52) U.S. Cl. 248/346.03

(57) ABSTRACT

Apparatus for retaining objects on the dashboard of a vehicle, comprising a planar rubbery base member having a bottom with a high friction surface characteristic is provided. The planar rubbery base member is made of a material which tends to conform to a shape of a curved surface upon which it is placed, such as the dashboard and a plurality of flexible walls extend upwardly from the rubbery base member. The walls define at least one compartment. A combination of high walls, and multifunction catching/gripping platforms configured and/or oriented differently and contained within the walls combine to effectively retain objects.

### TECHNICAL FIELD

The invention relates to devices for containing and/or localizing objects within the undistracted view of the driver of an automobile and within the driver's easy reach.

### CROSS REFERENCE TO RELATED APPLICATIONS

Not applicable.

### STATEMENT REGARDING FEDERALLY SPONSORED RESEARCH OR DEVELOPMENT

Not applicable

### BACKGROUND OF THE INVENTION

Today, there is an increasing awareness of the necessity for minimizing driver distraction during the driving of an automobile, while at the same time providing accessibility to modern conveniences and driving aids. The quality of driver performance while driving an automobile may be benefited by numerous devices, such as sunglasses, mobile phones, portable music players, access to change, access to a parking pass card, a GPS system, and so forth.

### SUMMARY OF THE INVENTION

In accordance with the invention, a caddy for containing and/or stabilizing the position of a multiplicity of objects is provided. It may be placed on a car dashboard, center console or other convenient surface on a car or other vehicle or other surface. More particularly, the inventive caddy is configured for dashboard mounting, without the necessity for a permanent adhesive, although the inventive structure may be employed with such adhesive for added structural security. The inventive caddy is constructed in a manner which overcomes the instability associated with putting objects on downwardly oriented and curved dashboards.

In accordance with the invention, apparatus for retaining objects on the dashboard of a vehicle, comprising a planar rubbery base member having a bottom with a high friction surface characteristic is provided. The planar rubbery base member is made of a material which tends to conform to a shape of a curved surface upon which it is placed, such as the dashboard and a plurality of flexible walls extend upwardly from the rubbery base member. The walls define at least one compartment. A combination of high walls and catching and gripping platforms contained within the walls combine to effectively retain objects.

The inventive apparatus may further comprise a plurality of top surface gripper platforms disposed within the compartment. The top surface gripper platforms have an area substantially smaller than the area of the top of the planar rubbery base member.

The top surface gripper platforms may be angularly oriented in a plurality of directions.

The top surface gripper platforms may comprise a plurality of elongated members.

The caddy may further comprise a plurality of bottom surface gripper platforms disposed on the bottom of the planar rubbery base member. The bottom surface gripper platforms have an area substantially smaller than the area of the bottom of the planar rubbery base member.

The top surface gripper platforms may comprise a plurality of elongated members.

The inventive caddy may further comprise a plurality of top surface gripper platforms disposed within the compartment. The top surface gripper platforms may have an area substantially smaller than the area of the top of the planar rubbery base member.

A plurality of bottom surface gripper platforms may be disposed on the bottom of the planar rubbery base member. The bottom surface gripper platforms they have an area substantially smaller than the area of the bottom of the planar rubbery base member.

Gaps may be defined between the plurality of flexible walls.

The flexible walls may be flush with the edges of the planar rubbery base member.

The bottom surface of the planar rubbery base member may be provided with a self adhesive material.

The bottom surface of the planar rubbery base member may be provided with a perimeter wall.

### BRIEF DESCRIPTION THE DRAWINGS

The operation of the invention will become apparent from the following description taken in conjunction with the drawings, in which:

FIG. 1 is a perspective view of a caddy constructed in accordance with the present invention;

FIG. 2 is a front view of the caddy of FIG. 1;

FIG. 3 is a rear view of the caddy of FIG. 1;

FIG. 4 is a left side elevational view of the caddy of FIG. 1;

FIG. 5 is a right side elevational view of the caddy of FIG. 1;

FIG. 6 is a top plan view of the caddy of FIG. 1;

FIG. 7 is a bottom plan view of the caddy of FIG. 1;

FIG. 8 illustrates a bottom plan view of an alternative embodiment of the inventive caddy;

FIG. 9 illustrates a top plan view of another alternative embodiment of the inventive caddy with a space for receiving alphanumeric information in accordance with the invention;

FIG. 10 is a bottom plan view of yet another alternative embodiment;

FIG. 11 is a perspective view of still yet another embodiment of the caddy of present invention;

FIG. 12 is bottom plan view of an alternative bottom surface for a caddy constructed in accordance with the present invention;

FIG. 13 illustrates in top plan view yet another alternative embodiment of the present invention utilizing a series of internal retainer fences;

FIG. 14 is a bottom plan view of the embodiment of FIG. 13;

FIG. 15 illustrates in perspective yet even another embodiment of the present invention without a perimeterial lip; and

FIG. 16 is a detail view, in perspective, of the embodiment of FIG. 15.

### DETAILED DESCRIPTION OF THE PREFERRED EMBODIMENTS

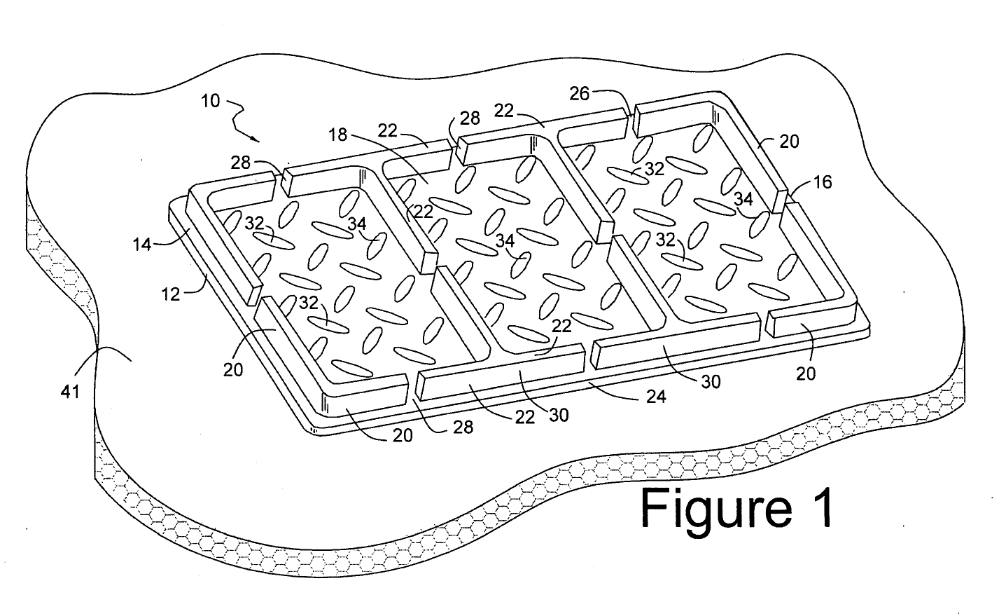

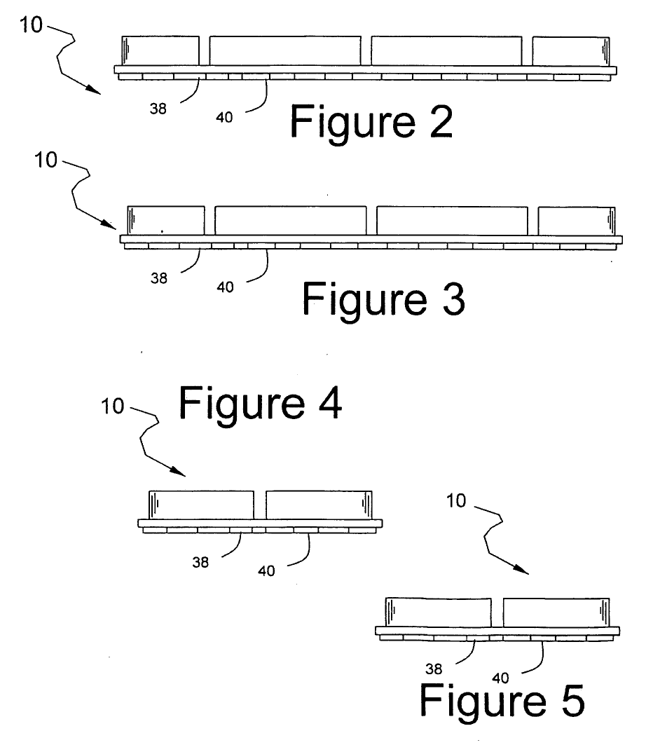

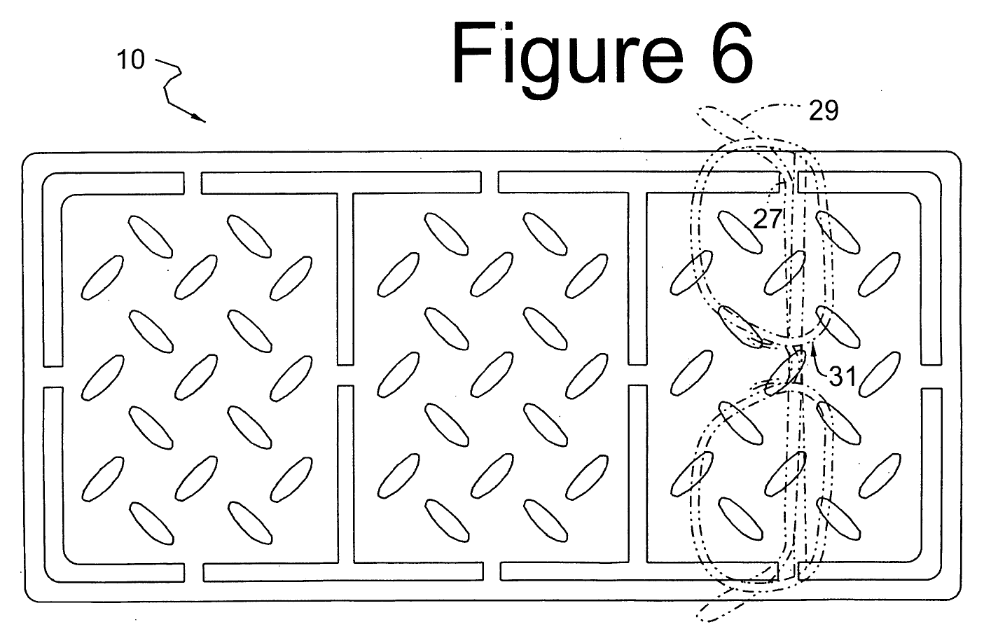

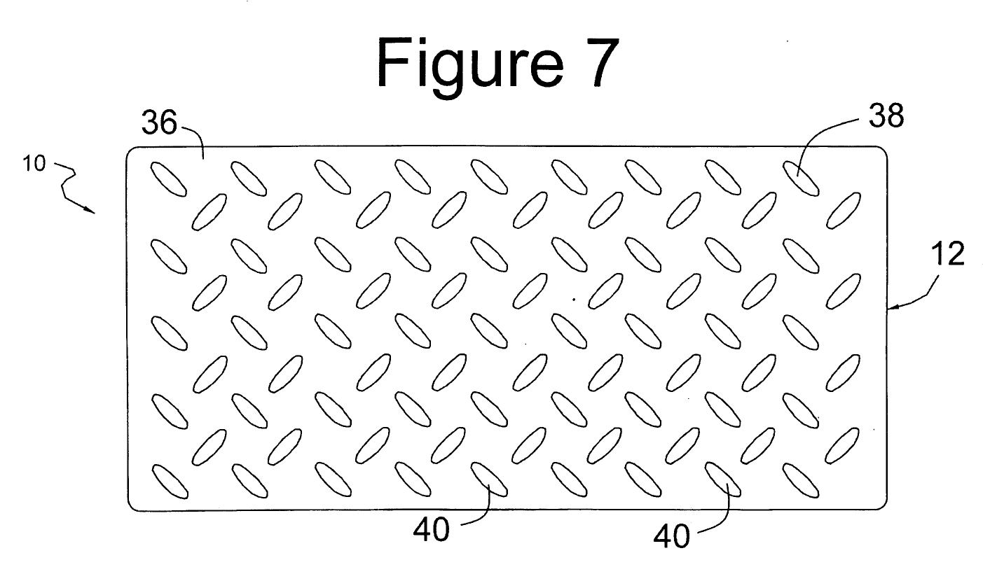

Reference is first made to FIGS. 1-7, where it may be seen that in accordance with the present invention, the inventive caddy 10 comprises a base 12. Base 12 defines a shoulder 14 on the periphery 16 of caddy 10. Base 12 defines a top surface 18.

A plurality of walls is supported on top surface 18. More particularly, L-shaped walls 20 are positioned at the corner of caddy 10. T-shaped walls 22 are positioned at the forward and rearward ends 24 and 26 of caddy 10.

A plurality of gaps 28 are defined between the ends of adjacent walls. Gaps 28 form catches for engaging objects held within caddy 10. Gaps 28 also allow a user to place an object like a cellular telephone or GPS in caddy 10 with the power cord, for example, passing through a gap 28. These catches are dimensioned to be large enough to engage objects likely to be carried in a car, such as the shank 27 of arms 29 of eyeglasses 31, or the operative and elongated portion of keys. At the same time, but catches must be small enough not to allow objects to through the gaps.

In accordance with the invention, L-shaped walls 20 and T-shaped walls 22 are sufficiently high to anchor objects commonly kept in an automobile. In addition, certain even larger objects, such as gloves will be anchored by the inventive caddy to the extent that they conform or may come to conform to the shape of caddy 10.

Additional stability is provided by angularly negatively oriented elevated gripper platforms 32 and by angularly positively oriented elevated gripper platforms 34. Angularly negatively oriented elevated gripper platforms 32 and angularly positively oriented elevated gripper platforms 34 are oriented to substantially transverse to each other. To the extent that angularly negatively oriented elevated gripper platforms 32 and angularly positively oriented elevated gripper platforms 34 and engage portions of objects in caddy 10 which are positioned below the tops of angularly negatively oriented elevated gripper platforms 32 and angularly positively oriented elevated gripper platforms 34, they will tend to catch a variety of forms. This will be encouraged by their substantially transverse orientations, which effectively ensures that at least a portion of the gripper platforms will be oriented in a manner more likely to make such engagement.

To the extent that portions of objects in caddy 10 are positioned above the tops of angularly negatively oriented elevated gripper platforms 32 and angularly positively oriented elevated gripper platforms 34, their smaller area will result in more weight per unit area of gripper platform surface, thus ensuring higher friction and thus a more effective gripping action, increasing the stability with which objects held in caddy 10 are maintained in a position.

Angularly negatively oriented elevated gripper platforms 32 and angularly positively oriented elevated gripper platforms 34 may have a thickness ranging between 0.1 cm and 0.5 cm.

Similarly, because angularly negatively oriented elevated gripper platforms 32 and angularly positively oriented elevated gripper platforms 34 are oriented substantially transverse to each other, on average they are more likely to effectively grip a variety of objects being subjected to substantially largely up-and-down vibrations and largely forward and rearward as well as leftward and rightward momentum was created by changes in the direction of the vehicle on the dashboard of which the inventive caddy 10 is positioned.

The bottom surface 36 of base 12 is populated with angularly negatively oriented elevated gripper platforms 38 and angularly positively oriented elevated gripper platforms 40. Angularly negatively oriented elevated gripper platforms 38 and angularly positively oriented elevated gripper platforms 40 are oriented substantially transverse to each other. The diversity of orientation of angularly negatively oriented elevated gripper platforms 38 and angularly positively oriented elevated gripper platforms 40 ensures good positional stability during vibrations and during the application of momentum forces. Angularly negatively oriented elevated gripper platforms 38 and angularly positively oriented elevated gripper platforms 40 may have a thickness ranging between 0.1 cm and 0.5 cm.

In accordance with the invention, inventive caddy 10 may be made out of rubber or a similar synthetic material. Materials having relatively high density, flexibility, a high coefficient of friction and compressibility are preferred. Weight ensures that the bottom surface of the inventive caddy 10 is securely gripped by the dashboard. Accordingly, high density material is desirable.

It is contemplated that the inventive caddy may have a width between 8 cm and 24 cm, and a length between 24 cm and 72 cm. Base 12 may have a thickness between 0.1 centimeters and 0.6 cm. L-shaped walls 20 and T-shaped walls 22 may have a thickness between 0.4 cm and 3 cm. Gaps 28 may range between 0.2 and 0.8 cm.

in use, the inventive caddy 10 is placed on the top of a dashboard 41, as illustrated in FIG. 1, where it is retained in place by friction, on account of the rubbery conforming high friction surfaces of gripper platforms 38 and 40.

In accordance with the invention, objects are placed within the rectangular areas defined between L-shaped walls 20 and T-shaped walls 22. To the extent that the dashboard of the automobile on which the inventive caddy 10 is placed, the combination of vibrations (due to irregularities in the road surface over which a vehicle is driving) and slant may cause migration of objects within caddy toward the forward portions 30 of L-shaped walls 20 and T-shaped walls 22.

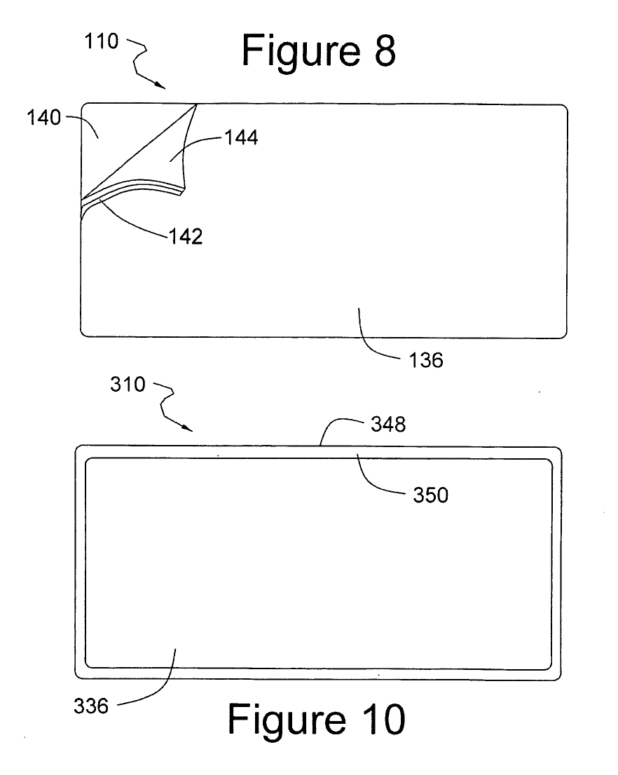

Turning to FIG. 8, it may be seen that in accordance with the invention, an alternative configuration or mechanism may be used to support the inventive caddy 110. In this embodiment and in the other embodiments discussed below, parts performing analogous or similar functions are numbered with numbers which are different from the analogous parts in the earlier embodiment by multiples of a hundred, where this numbering convention is practical and convenient.

Bottom 136 may be provided with a layer of self-adhesive material 140 in place of the gripper platforms 40 of FIGS. 1-7. Self-adhesive material 140 is manufactured with and continues to carry until used a protective member, of conventional design, made of polymer film or paper 142 coated with a release agent 144, such as wax. The thickness of paper 142 and release agent 144 is illustrated larger than scale for purposes of illustration.

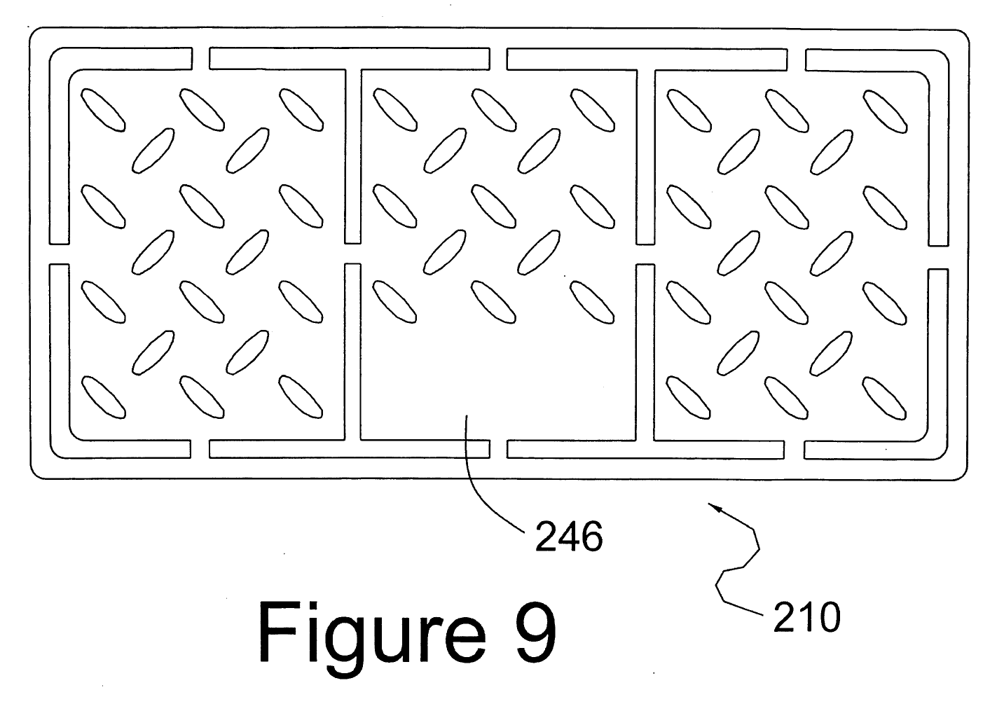

Referring to FIG. 9, another alternative in accordance with the present invention is illustrated. More particularly, caddy 210 has a top service including an unobstructed area 246 which is adapted to receive printed matter, such as the trademark of a manufacturer.

FIG. 10 illustrates another alternative embodiment of the inventive caddy 310 including a bottom 336 having outer perimeterial wall 348. Because of its reduced contact area 350, wall 348 has more of a tendency to conform to and form around irregularities in the dashboard surface, accordingly improving stability of the caddy 310 on the dashboard. Wall 348 should be a height sufficient to maintain the large surface area of bottom 336 largely elevated above the dashboard. For example, wall 348 may have a height extending from bottom 336 of 0.2 cm to 0.6 cm.

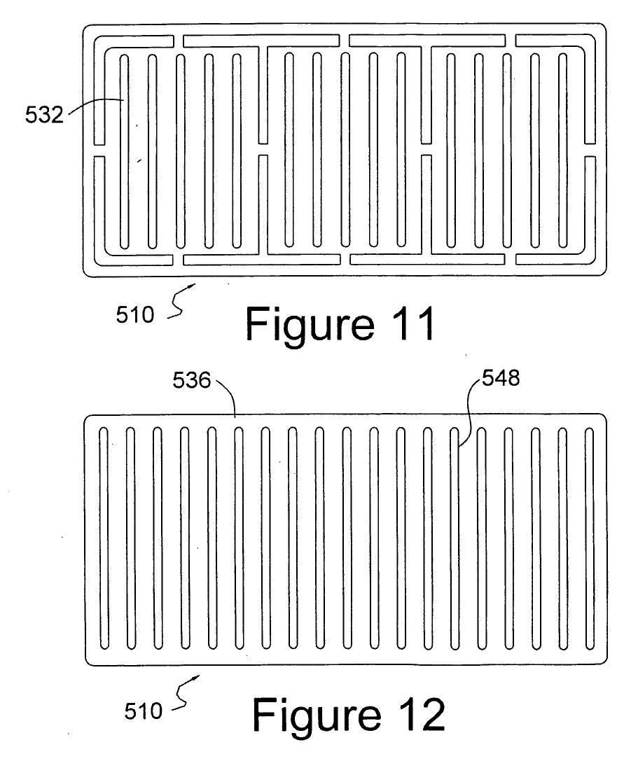

Referring to FIGS. 11 and 12, still yet another alternative embodiment of the inventive caddy 510 includes gripper platforms 532 which are elongated in the forward to rearward direction, but providing it a protection against momentum forces as the vehicle is turn to the right or to the left. Alternatively, elongated gripper platforms may be provided extending from the right to the left to provide better stability for objects in the caddy during acceleration and deceleration of the vehicle. This is particularly of value in the case of deceleration some account of sudden braking by the driver. Similarly, the bottom 536 of caddy 510 may be provided with elongated gripper walls 548.

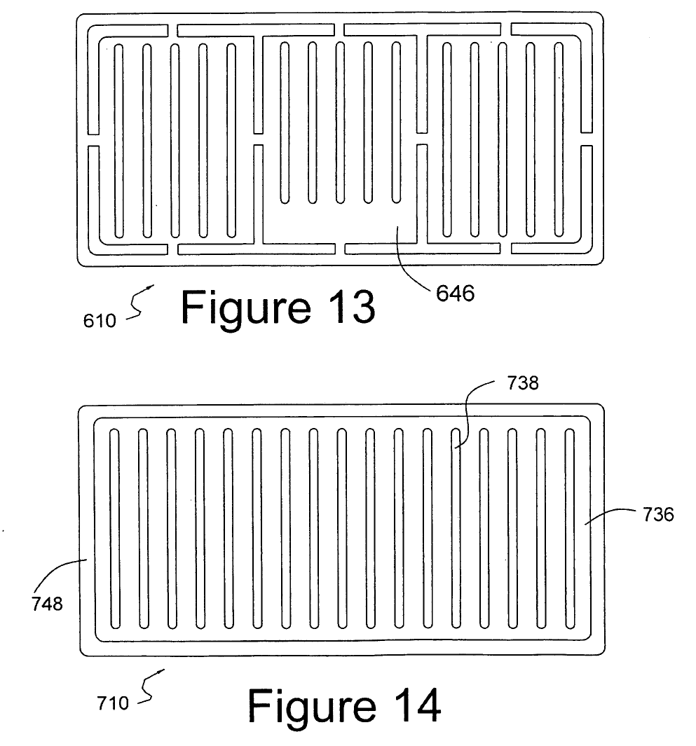

Turning to FIG. 13, a caddy 610 similar to the caddy in FIG. 11 is illustrated. Caddy 610 includes an open area 646 for receiving a printed imprint such as the trademark of a manufacturer. FIG. 14 illustrates a caddy 710 constructed in accordance with the present invention and having an alternative bottom 736. Bottom 736 is provided with a perimeterial wall 748 and gripper platforms 738.

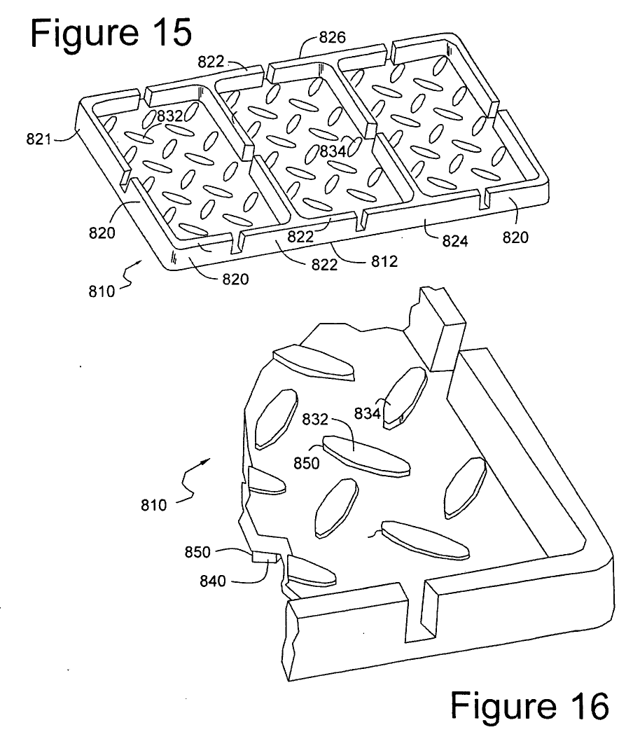

Referring to FIGS. 15 and 16, still yet another alternative embodiment of the inventive caddy 810 is illustrated. Caddy 810 is similar to the caddy illustrated in FIGS. 1-7, except that shoulder 14 is absent. Accordingly, L-shaped walls 820 are positioned at the corners of caddy 810 and extend to the side 821 of base. T-shaped walls 822 are positioned at the forward and rearward ends 824 and 826 of caddy 810. As in the embodiment of FIGS. 1-7, additional stability is provided by angularly negatively oriented elevated gripper platforms 832 and by angularly positively oriented elevated gripper platforms 834 which are the same as those used in the FIG. 1 embodiment. Also as in the indictment of FIGS. 1-7, the bottom 836 of caddy 810 is provided with gripper platforms 840. Gripper platforms 840, angularly negatively oriented elevated gripper platforms 832 and angularly positively oriented elevated gripper platforms 834 have a height 850 which is the same as the height of the gripper platforms in the FIG. 1 embodiment.

While a number of illustrative embodiments of the inventive caddy have been described above, it is recognized that certain modifications will be obvious to those of ordinary skill in the art. Such modifications are within the spirit and scope of the invention which is limited and defined only by the appended claims.

What is claimed is:

1. Apparatus for retaining objects on the dashboard of a vehicle, comprising:
(a) a planar rubbery base member having a bottom with a high friction surface characteristic, said planar rubbery base member tending to conform to a shape of a curved surface upon which it is placed; and
(b) a plurality of flexible walls extending upwardly from said rubbery base member, said walls defining at least one compartment.

2. Apparatus as in claim 1, further comprising:
(c) a plurality of top surface gripper platforms disposed within said compartment, said top surface gripper platforms having an area substantially smaller than the area of the top of said planar rubbery base member.

3. Apparatus as in claim 2, wherein some of said top surface gripper platforms are angularly oriented in a plurality of directions.

4. Apparatus as in claim 2, wherein said top surface gripper platforms comprise a plurality of elongated members.

5. Apparatus as in claim 1, further comprising:
a plurality of bottom surface gripper platforms disposed on the bottom of said planar rubbery base member, said bottom surface gripper platforms having an area substantially smaller than the area of the bottom of said planar rubbery base member.

6. Apparatus as in claim 5, wherein some of said top surface gripper platforms are angularly oriented in a plurality of directions.

7. Apparatus as in claim 5, wherein said top surface gripper platforms comprise a plurality of elongated members.

8. Apparatus as in claim 1, further comprising:
(c) a plurality of top surface gripper platforms disposed within said compartment, said top surface gripper platforms having an area substantially smaller than the area of the top of said planar rubbery base member;
(d) a plurality of bottom surface gripper platforms disposed on the bottom of said planar rubbery base member, said bottom surface gripper platforms having an area substantially smaller than the area of the bottom of said planar rubbery base member; and
(e) gaps are defined between said plurality of flexible walls.

9. Apparatus as in claim 1, further comprising:
(c) a plurality of top surface gripper platforms disposed within said compartment, said top surface gripper platforms having an area substantially smaller than the area of the top of said planar rubbery base member; and
(d) a plurality of bottom surface gripper platforms disposed on the bottom of said planar rubbery base member, said bottom surface gripper platforms having an area substantially smaller than the area of the bottom of said planar rubbery base member.

10. Apparatus as in claim 1, wherein said flexible walls are flush with the edges of said planar rubbery base member.

11. Apparatus as in claim 1, wherein the bottom surface of said planar rubbery base member is provided with a self adhesive material.

12. Apparatus as in claim 11, further comprising a protective member disposed over said self adhesive material.

13. Apparatus as in claim 1, wherein the bottom surface of said planar rubbery base member is provided with a perimeter wall.

14. Apparatus for retaining objects on the dashboard of a vehicle, comprising:
(a) a planar rubbery base member having a bottom with a high friction surface characteristic, said planar rubbery base member tending to conform to a shape of a curved surface upon which it is placed; and
(b) a plurality of flexible walls extending upwardly from said rubbery base member, said walls defining at least one compartment, and said walls having a first height; and
(c) a plurality of top surface gripper platforms disposed within said compartment, said top surface gripper platforms having an area substantially smaller than the area of the top of said planar rubbery base member, said gripper platforms having a second height, said second height being smaller than said first height, said gripper platforms and said flexible walls cooperating to effectively retain objects.

15. Apparatus as in claim 14, wherein said gripper platforms are contained within said flexible walls.

16. Apparatus as in claim 15, wherein said gripper platforms comprise a plurality of gripper platforms which are configured and/or oriented differently and contained within said flexible walls.

17. Apparatus as in claim 9, wherein said gaps are configured to receive and retain a cord associated with an object received between said flexible walls.
